(19) United States
(12) Patent Application Publication
(10) Pub. No.: US 2025/0164619 A1
(43) Pub. Date: May 22, 2025

(54) MULTI-SENSOR METROLOGY SYSTEM

(71) Applicant: Lumentum Operations LLC, San Jose, CA (US)

(72) Inventors: Alan HNATIW, Stittsville (CA); Herbert DAXAUER, Kössen (AT)

(21) Appl. No.: 18/431,113

(22) Filed: Feb. 2, 2024

Related U.S. Application Data
(60) Provisional application No. 63/601,868, filed on Nov. 22, 2023.

(51) Int. Cl. G01S 7/497; G01S 17/46; G01S 17/86; G01S 17/89

(52) U.S. Cl. CPC G01S 7/497; G01S 17/46; G01S 17/86; G01S 17/89

(57) ABSTRACT

In some implementations, a processing system may cause a plurality of optical sensors to measure a plurality of reference objects. The processing system may receive data indicating distances between the plurality of optical sensors and the plurality of reference objects. The processing system may compare the data to baseline data indicating baseline distances, between the plurality of optical sensors and the plurality of reference objects, measured by the plurality of optical sensors. The processing system may perform one or more corrective actions for the plurality of optical sensors based on differences between the data and the baseline data.

### CROSS-REFERENCE TO RELATED APPLICATION

This patent application claims priority to U.S. Provisional Patent Application No. 63/601,868, filed on Nov. 22, 2023, and entitled “CALIBRATION OF A MULTI-SENSOR METROLOGY SYSTEM.” The disclosure of the prior application is considered part of and is incorporated by reference into this patent application.

### TECHNICAL FIELD

The present disclosure relates generally to metrology and to a multi-sensor metrology system.

### BACKGROUND

Light detection and ranging (lidar) systems, such as time of flight (ToF)-based measurement systems, emit optical pulses, detect reflected optical pulses, and determine distances to objects by measuring delays between the emitted optical pulses and the reflected optical pulses.

### SUMMARY

In some implementations, a metrology system includes a structure that defines a bay in which an object for three-dimensional (3D) measurement is to be positioned, a plurality of reference objects attached to the structure, a plurality of optical sensors attached to the structure, where the plurality of reference objects are in fields of view of the plurality of optical sensors, and a processing system communicatively connected to the plurality of optical sensors. The processing system may be configured to cause the plurality of optical sensors to measure the plurality of reference objects. The processing system may be configured to receive, from the plurality of optical sensors, data indicating distances between the plurality of optical sensors and the plurality of reference objects. The processing system may be configured to compare the data to baseline data indicating baseline distances, between the plurality of optical sensors and the plurality of reference objects, measured by the plurality of optical sensors. The processing system may be configured to generate, based on differences between the data and the baseline data, a set of offsets to apply to one or more optical sensors of the plurality of optical sensors.

In some implementations, a method includes causing, by a processing system, a plurality of optical sensors to measure a plurality of reference objects. The method may include receiving, by the processing system from the plurality of optical sensors, data indicating distances between the plurality of optical sensors and the plurality of reference objects. The method may include comparing, by the processing system, the data to baseline data indicating baseline distances, between the plurality of optical sensors and the plurality of reference objects, measured by the plurality of optical sensors. The method may include performing, by the processing system, one or more corrective actions for the plurality of optical sensors based on differences between the data and the baseline data.

In some implementations, a metrology system includes a structure that defines a bay in which an object for 3D measurement is to be positioned. The metrology system may include a plurality of reference objects attached to the structure. The metrology system may include a plurality of lidar sensors attached to the structure. The plurality of reference objects may be in fields of view of the plurality of lidar sensors. One reference object, of the plurality of reference objects, may be in fields of view of multiple lidar sensors of the plurality of lidar sensors. Multiple reference objects, of the plurality of reference objects, may be in a field of view of one lidar sensor of the plurality of lidar sensors.

### BRIEF DESCRIPTION OF THE DRAWINGS

FIG. 1 is a perspective view of an example multi-sensor metrology system.

FIG. 2 is a diagram of an example environment in which systems and/or methods described herein may be implemented.

FIG. 3 is a diagram of example components of a device associated with a multi-sensor metrology system.

FIG. 4 is a flowchart of an example process associated with a multi-sensor metrology system.

### DETAILED DESCRIPTION

The following detailed description of example implementations refers to the accompanying drawings. The same reference numbers in different drawings may identify the same or similar elements.

Three-dimensional (3D) measurement of an object can be performed using an optical sensor that emits light (e.g., laser light) and detects reflections of the light from the object to capture data relating to spatial characteristics of the object. Sometimes, an object that is to undergo 3D measurement may be larger than a field of view of a single optical sensor and thus cannot be measured by the single sensor. Various techniques may be used to address this issue. For example, an optical sensor may be mounted on a robotic arm and moved to multiple positions around the object, the object may be mounted on the robotic arm and oriented in multiple positions relative to the optical sensor, the object may be mounted on a rotary stage and rotated to present different sides of the object to the optical sensor, or the object may be surrounded with a multitude of optical sensors.

Using robotic arms for 3D measurement entails the use of complicated safety curtains to prevent damage to an object being measured and/or to prevent injury to a person. Furthermore, programming robotic motion is complex, time consuming, and calls for specialized expertise. In addition, robotic arms are expensive, use safety equipment associated with additional cost, lack high positional accuracy (e.g., lack accuracy on a micrometer level), and have poor positional accuracy under temperature variations. Moreover, robotic arms are subject to wear (e.g., electrical cables need replacing periodically due to rubbing and/or mechanical joints deteriorate over time). When a single optical sensor is attached to a robotic arm, valid 3D measurements rely on accurately tracking a position of the robotic arm by using an external sensor, such as a laser tracker, or by employing photogrammetry, thereby introducing additional complexity and points of failure to a 3D measurement system. A multiple-sensor (multi-sensor) system is not susceptible to the aforementioned issues associated with robotic arms. Additionally, a multi-sensor system may provide improved speed relative to other techniques because the optical sensors of the multi-sensor system can operate simultaneously (i.e., in parallel) to capture 3D measurements of an object.

In some examples, optical sensors of a multi-sensor system may be mounted at various locations on a rigid frame to facilitate coverage for 3D measurement from multiple different angles. The frame may be constructed from a metal, such as steel. Despite the relatively high strength of metals, metals may experience expansion and contraction with temperature changes, thereby expanding and contracting the frame. Thus, the positions of the optical sensors mounted to the frame may shift as the frame expands and contracts. As a result, 3D measurements that are captured using the optical sensors may decrease in accuracy and reliability, or may become entirely unusable.

Some implementations described herein provide a multi-sensor metrology system for 3D measurement that is capable of highly accurate and reliable measurements. The metrology system may include multiple optical sensors and multiple reference objects, such as metal spheres, attached to a structure, such as a frame. At various times, the optical sensors may measure the reference objects to collect data indicating distances between the optical sensors and the reference objects. The data can be compared to baseline data, collected after a calibration of the metrology system, to identify movements of the relative positions of the optical sensors and/or the reference objects. These movements can be corrected by using calibration offsets for the optical sensors. Through regular measurement of the reference objects by the optical sensors, the calibration of the metrology system can be adjusted in real time to compensate for shifting of the optical sensors due to expansion and contraction of the structure, thereby maintaining a reliability and accuracy of the metrology system. In some implementations, the measurement of the reference objects by the optical sensors can be used to detect optical sensors or reference objects that are damaged, out of specification, or moved grossly out of position (e.g., due to an impact to the structure). This enables the metrology system to be kept in a high-performing state associated with efficiency improvements and error reduction.

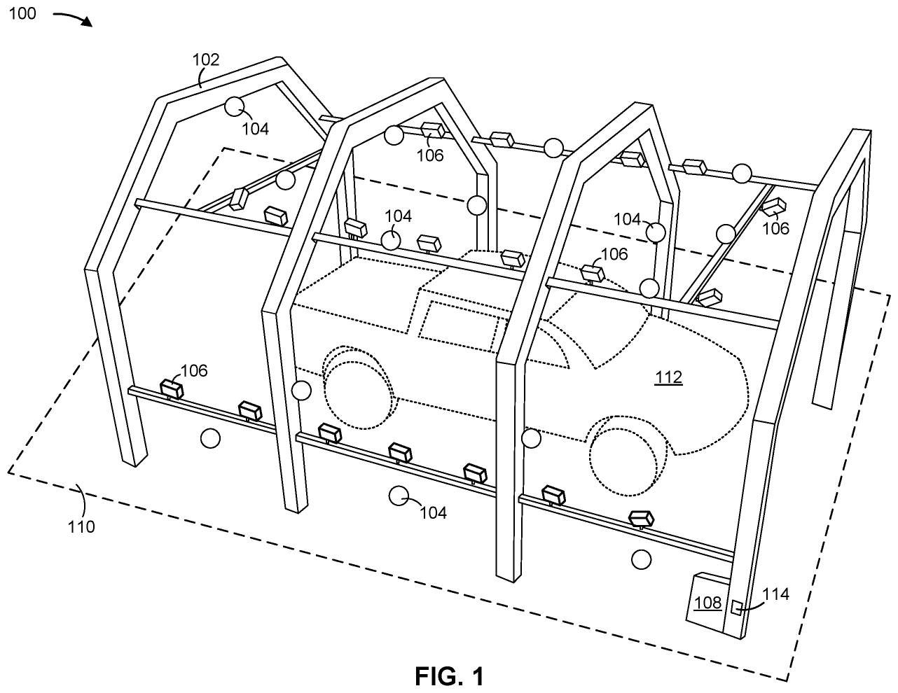

FIG. 1 is a perspective view of an example multi-sensor metrology system 100. As shown in FIG. 1, the metrology system 100 includes a structure 102, with a plurality of reference objects 104 and a plurality of optical sensors 106. In particular, the metrology system 100 may include two or more reference objects 104 (e.g., tens of reference objects 104) and two or more optical sensors 106 (e.g., tens of optical sensors 106) depending on a size of an object to be measured as well as fields of view and measurement volumes of the optical sensors 106. A quantity of reference objects 104 may be greater than, less than, or equal to a quantity of optical sensors 106. In some implementations, a reference object 104 and an optical sensor 106 may be integrated into a single unit. In some implementations, an externally-visible component of an optical sensor 106 may be a reference object 104. Additionally, the metrology system 100 includes a processing system 108 communicatively connected to the optical sensors 106.

The structure 102 is disposed (e.g., mounted) on a surface 110 (e.g., a ground surface). The structure 102 defines a bay, between the surface 110 and the structure 102, in which an object 112 for 3D measurement is to be positioned. The structure 102 may include a frame and/or paneling that partially encloses the object 112 when the object 112 is positioned in the bay defined by the structure 102. For example, the frame of the structure 102 may include a plurality of interlinked struts that form an arch-like enclosure that is open at opposite ends. The structure 102 may be composed of a material having a coefficient of thermal expansion of at least 8 parts per million per degree Kelvin (ppm/K), such as at least 11 ppm/K. For example, the structure 102 may be composed of steel. Accordingly, the structure 102 may expand or contract under temperature fluctuations. The surface 110 may be composed of a material having a lower coefficient of thermal expansion than the coefficient of thermal expansion of the structure 102. For example, the surface 110 may be composed of concrete. Accordingly, the surface 110 may be less susceptible to expansion and contraction under temperature fluctuations than the structure 102.

The object 112 may be positioned in the bay defined by the structure 102 manually or by one or more mechanical systems. For example, the metrology system 100 may include a conveyor system (not shown), such as a conveyor belt, a roller conveyor, a chain conveyor, a robotic conveyor, or the like, configured to transport objects 112 through the bay. The object 112 may include a machine or a machine part. For example, the object 112 may include a vehicle, as shown. Accordingly, the bay defined by the structure 102 may be large, such as at least 10 feet×10 feet (e.g., at least 15 feet×15 feet) in a horizontal dimension, and at least 10 feet (e.g., at least 15 feet) in a vertical dimension.

The reference objects 104 may be attached to the structure 102. For example, the reference objects 104 may be attached to the struts of the frame of the structure 102. Additionally, or alternatively, the metrology system 100 may include one or more additional reference objects 104 attached to the surface 110 (e.g., which is less likely to substantially expand and contract under temperature fluctuations than the structure 102). The reference objects 104 may include an array of uniformly sized and shaped objects that are relatively small compared to the object 112 being measured. As an example, a reference object 104 may include any object having a different shape than the object 112 being measured. A reference object 104 may include a sphere-shaped object, a cube-shaped object, a cone-shaped object, or an object of another shape. A reference object 104 may be composed of steel. In some implementations, a reference object 104 may have a retroreflective surface.

The optical sensors 106 may be attached to the structure 102. For example, the optical sensors 106 may be attached to the struts of the frame of the structure 102. An optical sensor 106 may be configured to emit an optical signal and to detect a reflection of the emitted optical signal from one or more objects, where the reflection of the optical signal indicates a respective distance between the optical sensor 106 and each of the object(s). In some implementations, an optical sensor 106 may be configured to detect a reflection of an optical signal emitted by another optical sensor 106 or another emitting device. An optical sensor 106 may include a time of flight (ToF) sensor. For example, an optical sensor 106 may include a direct ToF sensor or an indirect time of flight (iToF) sensor. In some implementations, an optical sensor 106 may include a lidar sensor. For example, the lidar sensor may use frequency modulated continuous wave (FMCW) lidar.

The optical sensors 106 may be arranged on the structure 102 such that the reference objects 104 are in fields of view of the optical sensors 106. For example, one reference object 104 may be in the fields of view of multiple optical sensors 106 (e.g., each of the reference objects 104 may be in the fields of view of multiple optical sensors 106). As another example, multiple reference objects 104 may be in the field of view of one optical sensor 106 (e.g., each of the optical sensors 106 may have multiple reference objects 104 in its field of view). This multiple-to-one configuration of the reference objects 104 and the optical sensors 106 enables identification of an impaired reference object 104 or optical sensor 106 with high accuracy, as described herein.

In some implementations, one or more of the optical sensors 106 may be dedicated for measuring reference objects 104 (e.g., these optical sensors 106 may be configured to measure only the reference objects 104). For example, a first set of the optical sensors 106 may perform measurement of the object 112 and reference objects 104, and a second set of the optical sensors 106 may be dedicated for measuring reference objects 104. In some implementations, the dedicated optical sensors 106 may be positioned on the structure 102, and corresponding reference objects 104 may be positioned on the structure 102 and/or on the surface 110, such that an optical sensor 106 has an unobstructed line of sight to a reference object 104 regardless of whether the object 112 is in the bay of the structure 102 (e.g., the line of sight is not obstructed even when the object 112 is in the bay of the structure 102). In some implementations, the optical sensors 106 may include multiple types of optical sensors. For example, a first set of the optical sensors 106 (e.g., the first set of the optical sensors 106 that performs measurement of the object 112 and reference objects 104) may be a first type of optical sensor and a second set of the optical sensors 106 (e.g., the second set of the optical sensors 106 dedicated for measuring reference objects 104) may be a second type of optical sensor. The first and second types of optical sensors may differ by detection technology (e.g., ToF sensors versus visible light cameras), resolution, field of view, or the like.

In some implementations, the optical sensors 106 may have finite absolute measurement ranges. For example, an optical sensor 106 may have an unambiguous range (e.g., up to approximately 2.5 meters), where an absolute distance of an object located away from the optical sensor 106 within the unambiguous range can be measured, but an absolute distance of an object located further away from the optical sensor 106 than the unambiguous range cannot be measured (e.g., for an unambiguous range up to 2.5 meters, measurements of an object located 2.6 meters from the optical sensor 106 could indicate a distance of 0.1 meters or 2.6 meters). In some implementations, a distance between an optical sensor 106 and a reference object 104, in a field of view of the optical sensor 106, is greater than an unambiguous range of the optical sensor 106. For example, the reference objects 104 and the optical sensors 106 can be positioned without regard to the unambiguous ranges of the optical sensors 106 because information relating to such positions can be stored by the processing system 108 and/or by the optical sensors 106 and used to resolve any such measurement ambiguities.

In some implementations, the metrology system 100 may include one or more additional sensors 114 communicatively connected to the processing system 108. The additional sensors 114 may be attached to the structure 102 and/or positioned near the structure 102. The additional sensors 114 may be unrelated to the 3D measurement performed by the optical sensors 106. For example, an additional sensor 114 may include a temperature sensor, a vibration sensor, a pressure sensor, and/or an accelerometer, among other examples. The additional sensors 114 may be configured to detect conditions that may be indicative of movement of the structure 102, the reference objects 104, and/or the optical sensors 106, as described herein.

The processing system 108 may be configured to control and/or process measurements taken by the optical sensors 106. In some implementations, the processing system 108 may perform an initial calibration operation to generate an initial calibration for the metrology system 100. The initial calibration operation may use a calibration object (not shown) for which highly precise measurements have been previously obtained (e.g., using a device other than the metrology system 100, such as a coordinate measurement machine). For the initial calibration operation, the calibration object may be positioned in the bay of the structure 102.

With the calibration object positioned, the processing system 108 may cause the optical sensors 106 to measure the calibration object. For example, the processing system 108 may transmit a signal to the optical sensors 106 that causes the optical sensors 106 to emit optical signals (e.g., optical pulses or continuous optical signals) and to detect reflections of the optical signals from the calibration object. The processing system 108 may receive, from the optical sensors 106, data indicating measurements collected by the optical sensors 106. Based on differences between the measurements collected by the optical sensors 106 and the known measurements of the calibration object, the processing system 108 may generate a set of offsets for one or more of the optical sensors 106 that calibrates the optical sensors 106 to a common coordinate system.

With the metrology system 100 calibrated (e.g., and with the calibration object removed from the bay of the structure 102), the processing system 108 may cause the optical sensors 106 to measure (e.g., using 3D sensing) the reference objects 104. For example, in a similar manner as described above, the processing system 108 may transmit a signal to the optical sensors 106 that causes the optical sensors 106 to emit optical signals (e.g., optical pulses or continuous optical signals) and to detect reflections of the optical signals from the reference objects 104. The processing system 108 may receive, from the optical sensors 106, data indicating distances between the plurality of optical sensors 106 and the reference objects 104. For example, the data received from each optical sensor 106 may indicate measurements relating to one or more reference objects 104 in the field of view of that optical sensor 106. The processing system 108 may store baseline data indicating the distances.

From time to time, the optical sensors 106 may re-measure the reference objects 104, which can allow the processing system 108 to detect movement of one or more optical sensors 106 and/or one or more reference objects using the baseline data. In some implementations, the optical sensors 106 may measure the reference objects 104 periodically (e.g., according to a predefined schedule). In some implementations, the optical sensors 106 may measure the reference objects in response to an occurrence of an event. For example, the processing system 108 may monitor sensor data (e.g., temperature data, acceleration data, or the like) from the additional sensors 114 and identify an occurrence of an event based on the sensor data. The event may be a change in temperature (e.g., relative to a temperature setting) that is greater than a threshold, an acceleration greater than a threshold (e.g., indicating a potential impact to the structure 102), or the like. The optical sensors 106 may measure the reference objects 104 while the bay of the structure 102 is empty (e.g., in a time period between objects 112 being positioned in the bay, in a time period between shifts of a facility using the metrology system 100, or the like). Additionally, or alternatively, the optical sensors 106 may measure the reference objects 104 while an object 112 is positioned in the bay of the structure 102 (e.g., using dedicated optical sensors 106 and corresponding reference objects 104, as described herein).

In accordance with a schedule for measuring the reference objects 104 (e.g., periodically), or responsive to detecting the occurrence of the event, the processing system 108 may cause the optical sensors 106 to measure (e.g., using 3D sensing) the reference objects 104. For example, in a similar manner as described above, the processing system 108 may transmit a signal to the optical sensors 106 that causes the optical sensors 106 to emit optical signals (e.g., optical pulses or continuous optical signals) and to detect reflections of the optical signals from the reference objects 104. The processing system 108 may receive, from the optical sensors 106, data indicating distances between the plurality of optical sensors 106 and the reference objects 104. For example, the data received from each optical sensor 106 may indicate measurements relating to one or more reference objects 104 in the field of view of that optical sensor 106.

As described above, the processing system 108 and/or the optical sensors 106 may store information that indicates approximate positions of the reference objects 104 and the optical sensors 106. This information may enable the processing system 108 and/or the optical sensors 106 to distinguish the reference objects 104 from other objects in a scene measured by the optical sensors 106. For example, the processing system 108 and/or the optical sensors 106 may discard or ignore portions of the data relating to locations other than the locations where the reference objects 104 are approximately positioned (e.g., in accordance with the information). Additionally, or alternatively, the processing system 108 and/or the optical sensors 106 may employ a shape-finding algorithm and/or a machine learning model that can identify a particular shape associated with the reference objects 104 (e.g., a sphere) in the data.

The processing system 108 may compare the data to the baseline data that indicates the baseline distances between the optical sensors 106 and the reference objects 104 as measured by the optical sensors 106. The processing system 108 may compare the data to the baseline data on a sensor-by-sensor basis. For example, the processing system 108 may compare the data collected by a first optical sensor 106 to the baseline data collected by the first optical sensor 106, may compare the data collected by a second optical sensor 106 to the baseline data collected by the second optical sensor 106, and so forth.

The processing system 108 may compare the data to the baseline data to identify differences between the data and the baseline data. For example, a difference between the data and the baseline data may indicate that an optical sensor 106 and/or a reference object 104 has moved from its previous position (e.g., due to thermal expansion of the structure 102, an impact to the optical sensor 106, an impact to the reference object 104, an impact to the structure 102, or the like). As an example, the differences between the data and the baseline data may be due to a temperature fluctuation that causes expansion or contraction of the structure 102. The processing system 108 may perform one or more corrective actions for the optical sensors 106 based on differences between the data and the baseline data.

As an example of a corrective action, the processing system 108 may generate, based on the differences between the data and the baseline data, a set of offsets to apply to one or more optical sensors 106. In some implementations, the set of offsets may be with respect to the common coordinate system of the initial calibration. For example, the set of offsets may correct for any movements of the optical sensors 106 away from their calibrated positions in the common coordinate system. In some implementations, the set of offsets may include distance offsets to apply to distance measurements collected by the optical sensors 106. The set of offsets may include an offset value for each of the optical sensors 106. An offset value for an optical sensor 106 may be zero (e.g., indicating that no offset is to be applied to the optical sensor 106) or a non-zero value (e.g., indicating an amount of offset that is to be applied to the optical sensor 106).

In some cases, a distance measurement of a reference object 104 made by an optical sensor 106, indicated in the data, may differ from a baseline distance measurement of the reference object 104 made by the optical sensor 106, in the baseline data, by a threshold amount (e.g., an amount greater than a difference that could reasonably occur due to thermal expansion). Accordingly, the processing system 108 may identify that the data and the baseline data, with respect to an optical sensor 106 and a reference object 104, differ by a threshold amount. The data and the baseline data differing by the threshold amount may indicate that the optical sensor 106 and/or the reference object 104 is impaired (e.g., damaged, out of specification, or moved grossly out of position).

In some implementations, the processing system 108 may identify which optical sensor 106 or reference object 104 is impaired by using distance measurements of the reference object 104 taken by other optical sensors 106 or by using distance measurements of other reference objects 104 taken by the optical sensor 106. For example, if three different optical sensors 106 have taken distance measurements of the same reference object 104, and if the data and the baseline data agree for two of the optical sensors 106 but differ for one of the optical sensors 106, then the processing system 108 may identify that the differing optical sensor 106 is impaired. As another example, if the optical sensor 106 has taken distance measurements of three different reference objects 104, and if the data and the baseline data agree for two of the reference objects 104 but differ for one of the reference objects 104, then the processing system 108 may identify that the differing reference object 104 is impaired.

As an example of a corrective action, the processing system 108 may transmit a notification indicating that the optical sensor 106 and/or the reference object 104 is impaired (e.g., responsive to the data and the baseline data, with respect to the optical sensor 106 and the reference object 104, differing by the threshold amount). For example, the notification may identify which optical sensor 106 or reference object 104 is impaired (e.g., using a sensor identifier or a reference object identifier, using a graphical depiction of the metrology system 100, or the like). The notification may be configured for presentation on a display of the metrology system 100 or for transmission as an email message, a text message, a push notification, or the like. In some implementations, the processing system 108 may cause activation of a warning indicator (e.g., an audible indicator and/or a visible indicator) of the metrology system 100 indicating that an optical sensor 106 and/or a reference object 104 is impaired. For example, each optical sensor 106 and reference object 104 may have a corresponding, nearby warning light, and the processing system 108 may cause activation of the warning light associated with an optical sensor 106 and/or a reference object 104 that is impaired. In some implementations, responsive to the impairment of an optical sensor 106 and/or a reference object 104, the processing system 108 may discard collected object measurement data (e.g., collected since a last valid measurement of the reference objects 104) and/or output a list identifying objects 112 (e.g., using object identifiers) measured since the last valid measurement.

Through regular measurement of the reference objects 104 using the optical sensors 106, the processing system can take appropriate corrective action to resolve deviations of the reference objects 104 and/or the optical sensors 106 from their expected positions due to expansion and contraction of the structure 102, impacts to the structure 102, or the like. In this way, the metrology system 100 may enable consistent and reliable 3D measurement.

As indicated above, FIG. 1 is provided as an example. Other examples may differ from what is described with regard to FIG. 1.

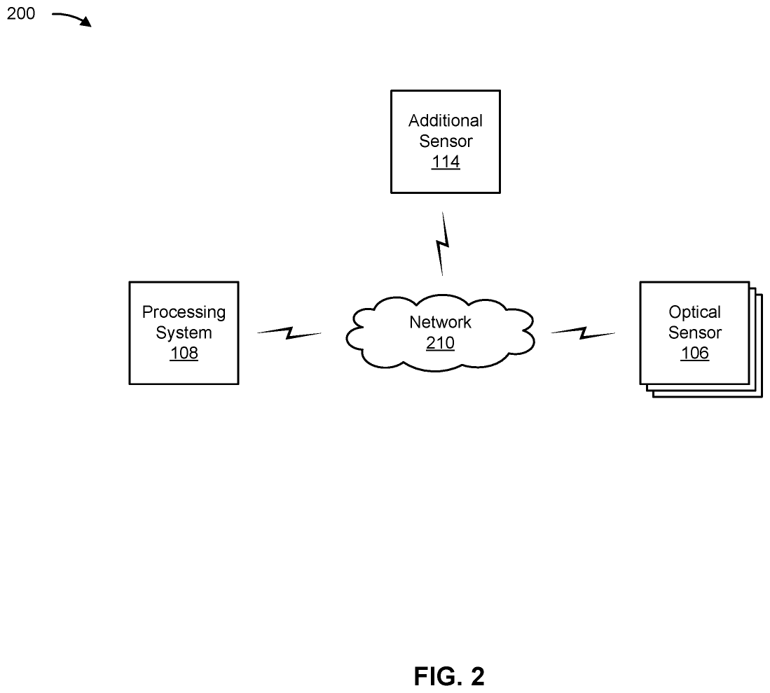

FIG. 2 is a diagram of an example environment 200 in which systems and/or methods described herein may be implemented. As shown in FIG. 2, environment 200 may include multiple optical sensors 106, a processing system 108, one or more additional sensors 114, and a network 210. Devices of environment 200 may interconnect via wired connections, wireless connections, or a combination of wired and wireless connections.

An optical sensor 106 may include one or more wired or wireless devices capable of receiving, generating, storing, transmitting, processing, detecting, and/or providing information associated with 3D measurement of an object, as described elsewhere herein. For example, the optical sensor may include a ToF sensor, a lidar sensor, or the like, as described herein. The optical sensor 106 may sense or detect a distance between the optical sensor 106 and an object and transmit, using a wired or wireless communication interface, an indication of the detected distance to the processing system 108 directly or via the network 210.

The processing system 108 may include one or more devices capable of receiving, generating, storing, processing, providing, and/or routing information associated with measurements collected by the optical sensors 106, as described elsewhere herein. The processing system 108 may include a communication device and/or a computing device. For example, the processing system 108 may include a server or a client device.

An additional sensor 114 may include one or more wired or wireless devices capable of receiving, generating, storing, transmitting, processing, detecting, and/or providing information associated with a condition of the metrology system 100 or an environment of the metrology system 100, as described elsewhere herein. For example, the additional sensor 114 may include a temperature sensor, a moisture sensor, a humidity sensor, an accelerometer, a gyroscope, and/or a pressure sensor, among other examples. The additional sensor 114 may sense or detect a condition or information and transmit, using a wired or wireless communication interface, an indication of the detected condition or information to the processing system 108 directly or via the network 210.

The network 210 may include one or more wired and/or wireless networks. For example, the network 210 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 210 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

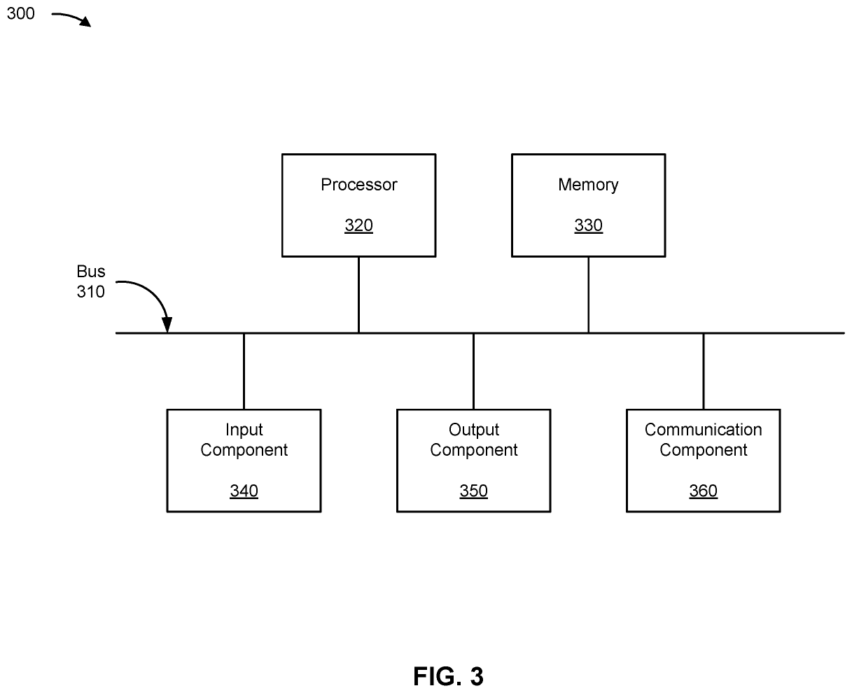

FIG. 3 is a diagram of example components of a device 300 associated with a multi-sensor metrology system. The device 300 may correspond to an optical sensor 106, the processing system 108, and/or an additional sensor 114. In some implementations, an optical sensor 106, the processing system 108, and/or an additional sensor 114 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a switch, a sensor, and/or an optical receiver. The output component 350 may enable the device 300 to provide output, such as via a display, a speaker, and/or a light source. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

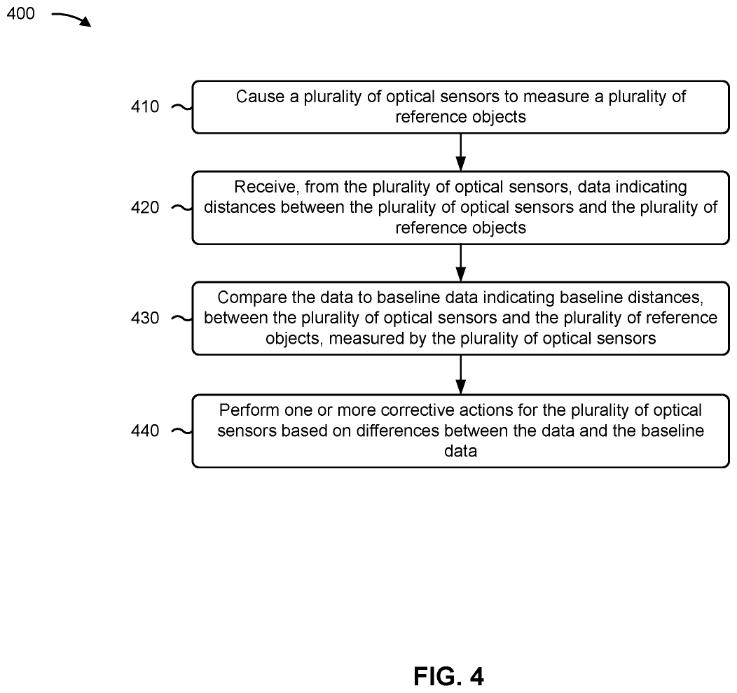

FIG. 4 is a flowchart of an example process 400 associated with a multi-sensor metrology system. In some implementations, one or more process blocks of FIG. 4 are performed by a processing system (e.g., processing system 108). In some implementations, one or more process blocks of FIG. 4 are performed by another device or a group of devices separate from or including the processing system, such as an optical sensor (e.g., optical sensor 106). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include causing a plurality of optical sensors to measure a plurality of reference objects (block 410). For example, the processing system (e.g., using processor 320, memory 330, and/or communication component 360) may cause a plurality of optical sensors to measure a plurality of reference objects, as described above.

As further shown in FIG. 4, process 400 may include receiving data indicating distances between the plurality of optical sensors and the plurality of reference objects (block 420). For example, the processing system (e.g., using processor 320, memory 330, and/or communication component 360) may receive data indicating distances between the plurality of optical sensors and the plurality of reference objects, as described above.

As further shown in FIG. 4, process 400 may include comparing the data to baseline data indicating baseline distances, between the plurality of optical sensors and the plurality of reference objects, measured by the plurality of optical sensors (block 430). For example, the processing system (e.g., using processor 320 and/or memory 330) may compare the data to baseline data indicating baseline distances, between the plurality of optical sensors and the plurality of reference objects, measured by the plurality of optical sensors, as described above.

As further shown in FIG. 4, process 400 may include performing one or more corrective actions for the plurality of optical sensors based on differences between the data and the baseline data (block 440). For example, the processing system (e.g., using processor 320, memory 330, output component 350, and/or communication component 360) may perform one or more corrective actions for the plurality of optical sensors based on differences between the data and the baseline data, as described above.

Process 400 may include additional implementations, such as any single implementation or any combination of implementations described below and/or in connection with one or more other processes described elsewhere herein.

In a first implementation, performing the one or more corrective actions includes generating, based on the differences between the data and the baseline data, a set of offsets to apply to one or more optical sensors of the plurality of optical sensors.

In a second implementation, alone or in combination with the first implementation, performing the one or more corrective actions includes transmitting a notification indicating that the at least one of an optical sensor, of the plurality of optical sensors, or a reference object, of the plurality of reference objects, is impaired responsive to the data and the baseline data, with respect to the optical sensor and the reference object, differing by a threshold amount.

In a third implementation, alone or in combination with one or more of the first and second implementations, the plurality of optical sensors and the plurality of reference objects are attached to a structure, and the plurality of reference objects are in fields of view of the plurality of optical sensors.

In a fourth implementation, alone or in combination with one or more of the first through third implementations, the differences between the data and the baseline data are due to a temperature fluctuation that causes expansion or contraction of the structure.

In a fifth implementation, alone or in combination with one or more of the first through fourth implementations, the plurality of optical sensors are iToF sensors.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a memory, a processor, or a optical sensor) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A metrology system, comprising:
a structure that defines a bay in which an object for three-dimensional (3D) measurement is to be positioned;
a plurality of reference objects attached to the structure;
a plurality of optical sensors attached to the structure,
wherein the plurality of reference objects are in fields of view of the plurality of optical sensors; and
a processing system, communicatively connected to the plurality of optical sensors, configured to:
cause the plurality of optical sensors to measure the plurality of reference objects;
receive, from the plurality of optical sensors, data indicating distances between the plurality of optical sensors and the plurality of reference objects;
compare the data to baseline data indicating baseline distances, between the plurality of optical sensors and the plurality of reference objects, measured by the plurality of optical sensors; and
generate, based on differences between the data and the baseline data, a set of offsets to apply to one or more optical sensors of the plurality of optical sensors.

2. The metrology system of claim 1, wherein the processing system is further configured to:
identify that the data and the baseline data, with respect to an optical sensor, of the plurality of optical sensors, and a reference object, of the plurality of reference objects, differ by a threshold amount,
wherein the data and the baseline data differing by the threshold amount indicates impairment of at least one of the optical sensor or the reference object; and
transmit a notification indicating that the at least one of the optical sensor or the reference object is impaired.

3. The metrology system of claim 1, further comprising one or more additional sensors communicatively connected to the processing system,
wherein the one or more additional sensors comprise one or more of a temperature sensor or an accelerometer.

4. The metrology system of claim 3, wherein the processing system is further configured to:
monitor sensor data from the one or more additional sensors; and
identify an occurrence of an event based on the sensor data,
wherein the processing system is configured to cause the plurality of optical sensors to measure the plurality of reference objects responsive to the occurrence of the event.

5. The metrology system of claim 1, wherein the structure is on a surface, and
wherein one or more additional reference objects are attached to the surface.

6. The metrology system of claim 1, wherein the plurality of optical sensors are indirect time of flight (iToF) sensors.

7. The metrology system of claim 1, wherein one reference object, of the plurality of reference objects, is in fields of view of multiple optical sensors of the plurality of optical sensors.

8. The metrology system of claim 1, wherein multiple reference objects, of the plurality of reference objects, are in a field of view of one optical sensor of the plurality of optical sensors.

9. A method, comprising:
causing, by a processing system, a plurality of optical sensors to measure a plurality of reference objects;
receiving, by the processing system from the plurality of optical sensors, data indicating distances between the plurality of optical sensors and the plurality of reference objects;
comparing, by the processing system, the data to baseline data indicating baseline distances, between the plurality of optical sensors and the plurality of reference objects, measured by the plurality of optical sensors; and
performing, by the processing system, one or more corrective actions for the plurality of optical sensors based on differences between the data and the baseline data.

10. The method of claim 9, wherein performing the one or more corrective actions comprises:
generating, based on the differences between the data and the baseline data, a set of offsets to apply to one or more optical sensors of the plurality of optical sensors.

11. The method of claim 9, wherein performing the one or more corrective actions comprises:
transmitting a notification indicating that the at least one of an optical sensor, of the plurality of optical sensors, or a reference object, of the plurality of reference objects, is impaired responsive to the data and the baseline data, with respect to the optical sensor and the reference object, differing by a threshold amount.

12. The method of claim 9, wherein the plurality of optical sensors and the plurality of reference objects are attached to a structure, and
wherein the plurality of reference objects are in fields of view of the plurality of optical sensors.

13. The method of claim 12, wherein the differences between the data and the baseline data are due to a temperature fluctuation that causes expansion or contraction of the structure.

14. The method of claim 9, wherein the plurality of optical sensors are time of flight (ToF) sensors.

15. A metrology system, comprising:
a structure that defines a bay in which an object for three-dimensional (3D) measurement is to be positioned;
a plurality of reference objects attached to the structure; and
a plurality of lidar sensors attached to the structure,
wherein the plurality of reference objects are in fields of view of the plurality of lidar sensors,
wherein one reference object, of the plurality of reference objects, is in fields of view of multiple lidar sensors of the plurality of lidar sensors, and
wherein multiple reference objects, of the plurality of reference objects, are in a field of view of one lidar sensor of the plurality of lidar sensors.

16. The metrology system of claim 15, wherein a distance between a lidar sensor, of the plurality of lidar sensors, and a reference object, of the plurality of reference objects, in a field of view of the lidar sensor, is greater than an unambiguous range of the lidar sensor.

17. The metrology system of claim 15, further comprising one or more additional sensors attached to the structure,
wherein the one or more additional sensors comprise one or more of a temperature sensor or an accelerometer.

18. The metrology system of claim 15, wherein the structure is composed of a material having a coefficient of thermal expansion of at least 8 parts per million per degree Kelvin.

19. The metrology system of claim 15, wherein the plurality of reference objects are uniformly sized and shaped.

20. The metrology system of claim 15, wherein a first set of the plurality of lidar sensors are a first type of lidar sensor and a second set of the plurality of lidar sensors are a second type of lidar sensor.
